(19) United States
(12) Patent Application Publication
(10) Pub. No.: US 2011/0290013 A1
(43) Pub. Date: Dec. 1, 2011

(54) Motionless liquid level gauge having three electrodes

(75) Inventors: Volodia Naydenoy, Louvain-la-neuve (BE); Laurent Morgana, Paris (FR)

(73) Assignee: INERGY AUTOMOTIVE SYSTEMS RESEARCH (Societe Anonym e), Brussels (BE)

(21) Appl. No.: 13/147,697

(22) PCT Filed: Feb. 9, 2010
(86) PCT No.: PCT/EP2010/051592

§ 371 Date: Aug. 3, 2011

(30) Foreign Application Priority Data
Feb. 11, 2009 (EP) 09152537.8
Apr. 3, 2009 (EP) 09157315.4

(51) Int. Cl. G01F 23/26

(52) U.S. Cl. 73/304 C

(57) ABSTRACT

A capacitive probe comprises a first electrode, a second electrode, and a third electrode. A cap is positioned on a first end of the first electrode and a first end of the second electrode. A base is positioned on a second end of the first electrode, a second end of the second electrode, and a second end of the third electrode. A support is positioned on a first end of the third electrode and in contact with a surface of the second electrode. The electrodes can be coaxial cylinders or parallel plates. The gauge can be used with a system for measuring a quantity and quality of a liquid, more specifically, of an aqueous urea solution in the tank of an SCR system.

### CROSS-REFERENCE TO RELATED APPLICATIONS

This application is a U.S. national stage entry under 35 U.S.C. §371 of International Application No. PCT/EP2010/051592 filed Feb. 9, 2010, which claims priority to European Application No. 09152537.8 filed Feb. 11, 2009 and European Application No. 09157315.4 filed Apr. 3, 2009, these applications being herein incorporated by reference in their entirety for all purposes.

### TECHNICAL FIELD OF THE INVENTION

The present description relates to a capacitive type liquid level sensor, and specifically to a three-cylinder motionless gauge, including a three-cylinder capacitive probe, an electronic device and the associated operational logic, that can be used to measure an amount (level or volume) and the purity of a liquid.

### BACKGROUND

Numerous devices have been proposed to date for measuring the level of liquid in the tanks, and in particular, in the fuel tanks of motor vehicles. These known devices normally use level sensors or gauges that deliver a signal representative of the level of fuel in the tank.

Motor vehicles utilizing an SCR (Selective Catalytic Reduction) process, which serves to reduce the nitrogen oxides by injecting a reducing agent, generally ammonia, into the exhaust line, require tanks to store the solution containing the reducing agent. One such solution can be a urea solution, for example a commercial solution available under the name AdBlue®. More and more often, car manufacturers require the amount of such a solution to be measured as well, preferably continuously and all over the range of capacity.

For the purpose of measuring liquid levels in such tanks, capacitive gauges have been developed. U.S. Pat. No. 6,490,920 describes such kind of gauges, which are essentially of two kinds: uniform-field gauges involving capacitance “plates” (generally flat or cylindrical) and fringing fields capacitors of the PCB type. The latter, which generally comprise conductive circuits (electrodes) printed on an insulated support, cannot be used to measure the level in a urea container because the electrodes are generally made of copper, which is sensitive to corrosion. On the other hand, the capacitance plates which are described in this US patent do not allow to measure a level of liquid which would be below the upper edge of the reference capacitor and besides, their measurement is sensitive to contaminants which would concentrate in the bottom.

### SUMMARY OF THE INVENTION

The present invention aims at solving these problems and at providing a tank and a method and apparatus for measuring the level of liquid (namely a corrosive liquid like a water/urea solution) within said tank over its entire filling range, which can evaluate the purity of the liquid (urea for instance) and which is simple and takes not much space inside the tank. In that regard, the invention concerns a tank of an SCR system equipped with a liquid level sensor (or gauge) comprising three plates or cylinders of conductive material which are fixed and rise up from the bottom of the tank, said plates or cylinders:
being spaced from each other but in a way such that their surfaces are parallel, and
having all three the same width in the case of plates, but only two of them, which are next to each other, having the same height while the third one is shorter (has a smaller height and hence, a smaller surface than the others).

With such a geometry, the two higher plates/cylinders can be used as measuring capacitor while the shortest plate/cylinder and the longer one adjacent to it, can be used as a reference capacitor of a level gauge, provided adequate electronics and charging means are added.

The spacing of the plates and their parallelism is an important factor for the precision of the measurement of such a gauge. Hence, the present invention also aims at providing a level gauge with a given geometry ensuring this spacing (parallelism), and which will be described in detail below.

Finally, the present invention also aims at providing a method for using such a gauge in order to measure a liquid level into a tank, and which will also be described in detail below. Advantageously, this method measures both the level of aqueous urea solution in a tank of an SCR system, and the quality (composition) of said solution and this with a single apparatus (namely: a level gauge which will be described in detail below). To date, two separate devices/methods were used to perform these measurements, which implies additional costs and risks of failure. It is namely so that the quality (composition) of the solution is important for the effective depollution of engine exhaust gases.

As explained above, the present invention includes a capacitive probe with a first electrode, a second electrode, and a third electrode.

In a preferred embodiment, a cap can be positioned on a first end of the first electrode and a first end of the second electrode; a base can be positioned on a second end of the first electrode, a second end of the second electrode, and a second end of the third electrode; and a support can be positioned on a first end of the third electrode and in contact with a surface of the second electrode. In this embodiment, the cap preferably has openings to allow the liquid to enter into the probe and the base can have at least three openings through which connectors can extend from the electrodes.

If the electrodes are cylindrical, the cap may fit around the upper ends of the highest ones (for instance, of the outer cylinder and the middle cylinder) to encapsulate these end portions. Similarly, the base may fit around the lower end of the 3 cylinders to encapsulate these end portions. Finally, the support may be positioned on the top end of the inner cylinder such that it does not extend to the top end of the middle cylinder and does not contact the outer cylinder.

Another exemplary embodiment of the present invention includes a motionless gauge and method for measuring a quantity and purity of a liquid with a three-cylinder capacitive probe as described above and an electronic device with the associated operational logic. The electronic device measures a first capacity value from the capacitor realized by the first and the second cylinder, measures a second capacity value from the capacitor realized by the second and the third cylinder. The electronic device can calculate the quantity of the liquid from the first measured capacity value. Additionally, the electronic device can determine the purity (quality) of the liquid from the second capacity value.

The invention also relates to a system for measuring a quantity and quality of a liquid in a urea tank comprising a gauge such as in the previous exemplary embodiment. It is worth noting that since urea/water solutions are corrosive, the materials of both the tank and the gauge should be chosen accordingly. Also, in order to avoid vapors from being discharged in the atmosphere, said tank is preferably equipped with a venting circuit including a canister and lines of which again, the material should be chosen resistant to urea. HDPE (or high density polyethylene) especially for the tank, the canister and the venting lines, and some grades of steel for the elements of the gauge, give good results in that regard.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 depicts an exemplary embodiment of a three-cylinder motionless probe;

FIG. 2 depicts an exploded view of the three-cylinder capacitive probe shown in FIG. 1;

FIG. 3 depicts a cross-sectional view of the three-cylinder capacitive probe shown in FIG. 1;

FIG. 4 depicts a diagram of an exemplary embodiment of a three-cylinder motionless gauge;

FIG. 5 depicts a flow chart of the logic of operation of a three-cylinder motionless gauge utilizing a three-cylinder capacitive probe;

FIG. 6 depicts a table including measurement results from the exemplary embodiment shown in FIG. 4;

FIG. 7 depicts a graphical representation of the measurement results shown in FIG. 6; and

FIG. 8 depicts a graphical representation of measurement results from an exemplary embodiment including parallel plates.

### DETAILED DESCRIPTION OF THE PREFERRED EMBODIMENTS

Although these figures relate to specific embodiments, the preferred features set forth therein can be generalized to other embodiments. It is also worth noting that like reference numerals designate identical or corresponding parts throughout the several views.

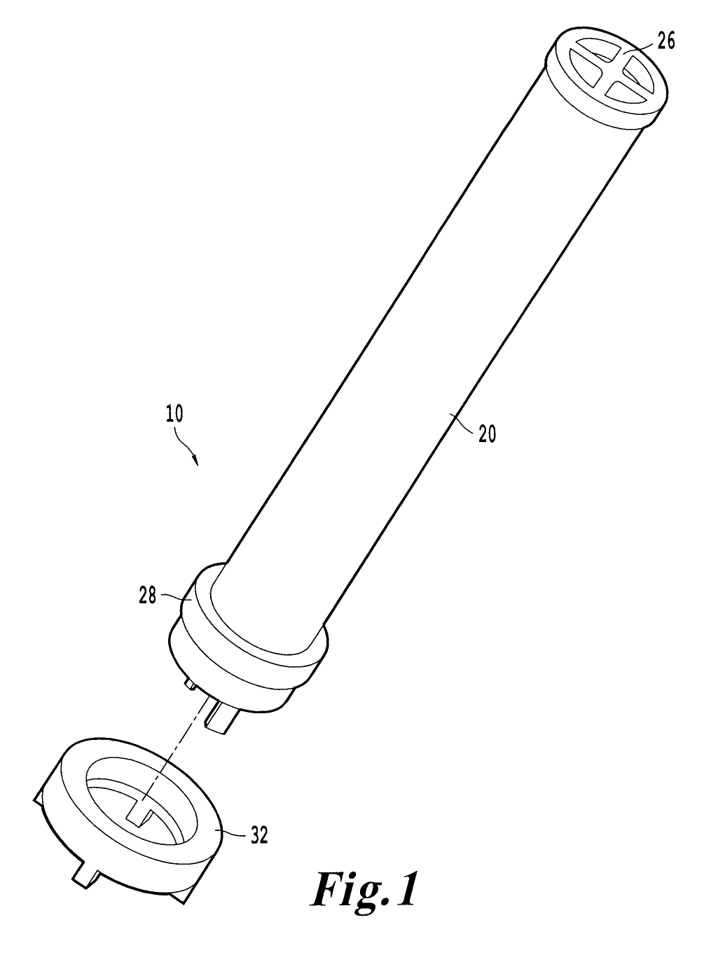

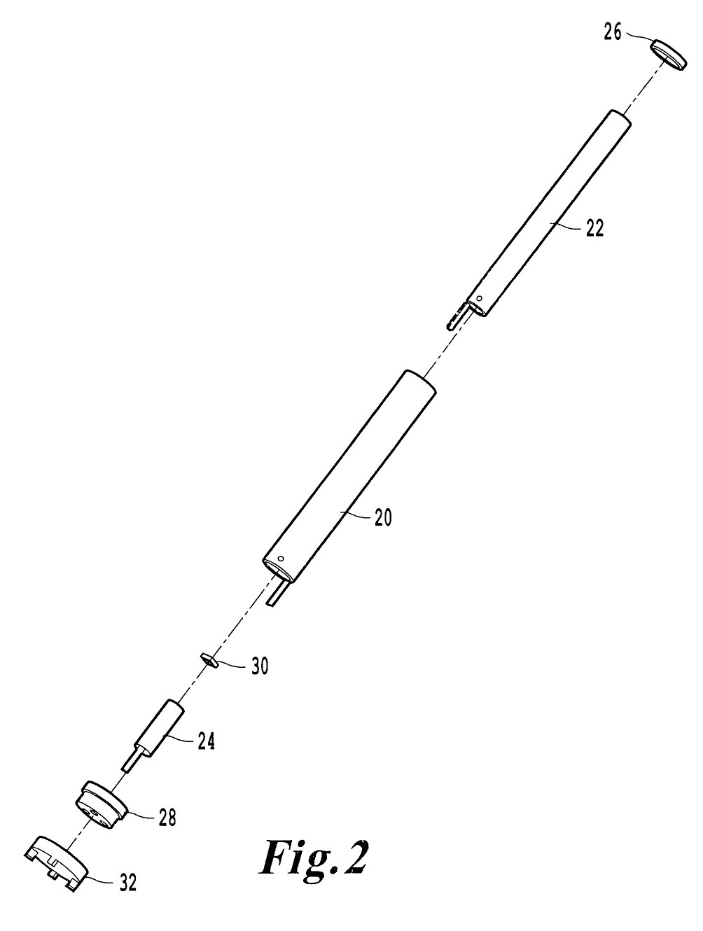

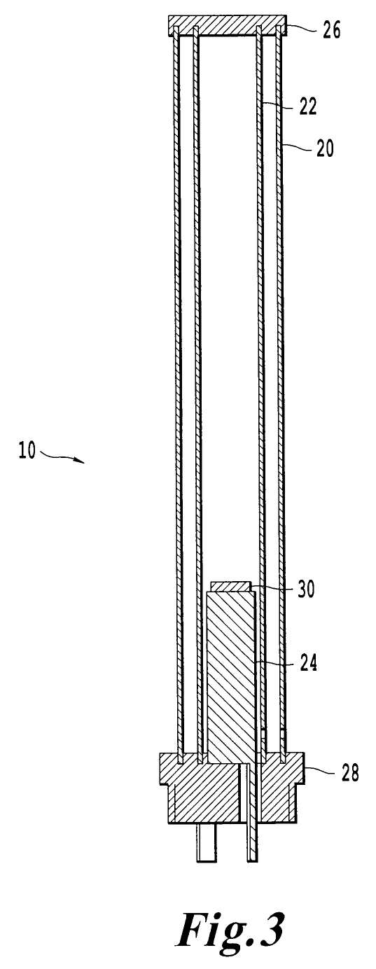

FIGS. 1-3 depict an exemplary embodiment of a three-cylinder capacitive probe 10. FIG. 1 shows the three-cylinder capacitive probe 10 in an assembled state. FIG. 2 shows an exploded view of the three-cylinder capacitive probe 10. FIG. 3 shows a cross-sectional view of the three-cylinder capacitive probe 10.

The probe 10 includes an outer cylinder 20, a middle cylinder 22, and an inner cylinder 24. The inner cylinder 24 can be a hollow or full (solid) cylinder. These three cylinders (20, 22, and 24) are positioned coaxially.

As discussed further below, each of the three cylinders (20, 22, and 24) can function as an electrode. More specifically, in the pictured embodiment, cylinders (20, 22) and (22, 24) are acting as two electrodes, respectively the measuring and the reference electrode. Thus, the three cylinders (20, 22, and 24) should be accurately positioned with respect to one another. Accordingly, the probe 10 includes a cap 26 to which the outer cylinder 20 and the middle cylinder 22 can be attached. Additionally, the probe 10 includes a base 28 to which the outer cylinder 20, the middle cylinder 22, and the inner cylinder 24 can be attached. Thus, the outer cylinder 20 and the middle cylinder 22 can be positioned with respect to one another via the cap 26 and the base 28.

Further, the inner cylinder 24 can have a support 30 positioned on an end of the inner cylinder 24 that is opposite to the end attached to the base 28. The support 30 can have a square shape such that the corners of the support 30 are pressed against an interior wall of the middle cylinder 22 to position the inner cylinder 24 along with the attachment to the base 28. Alternatively, the support 30 can have another shape as long as the inner cylinder 24 is maintained in place and the liquid can pass through the support 30. The material of the support 30 can be polyamide 6.6, for example, or another suitable electrical insulator. The material of the three cylinders (20, 22, and 24) can be stainless steel, for example, or another suitable electrically conductive material. In a preferred embodiment, the cylinders are free of copper. The stainless steel material can resist the corrosive effect of the material measured by the probe 10, such as a urea solution. These materials are preferred within the frame of the invention, whatever the shape of the probe.

The base 28 to which the three cylinders (20, 22, and 24) can be attached can be positioned within a stand 32. The stand allows for a tight assembly of the three cylinders (20, 22, and 24). The stand 32 can be integrated with the bottom of the liquid container so as to prevent any leakage of the liquid. The use of such a stand is hence preferred within the frame of the invention, whatever the shape of the probe.

As discussed above, each of the three cylinders (20, 22, and 24) can function as an electrode. In a preferred embodiment, the three cylinders are electrically isolated from each other. For example, the walls of the cylinders can be coated with a film of insulator. Additionally, the cap 26 and the base 28 can be made of, or coated with, electrical insulators. Accordingly, the probe 10 can be used to determine a level of a liquid, such as a urea solution, in a tank. The tank can be part of a selective catalytic reduction (SCR) system. Additionally, the probe 10 can be used to determine a purity of the liquid, such as detecting fuel in the urea solution or poor urea quality.

The following is a discussion of one exemplary embodiment in which the probe 10 is used as part of a level gauge to determine a level and purity of a urea solution (like AdBlue®) in a tank. Such a measurement could be utilized in an SCR system aimed at reducing the NOx emissions from a motor vehicle, by being injected into its exhaust gases. The probe 10 must hence be positioned on the bottom of the reducing agent tank.

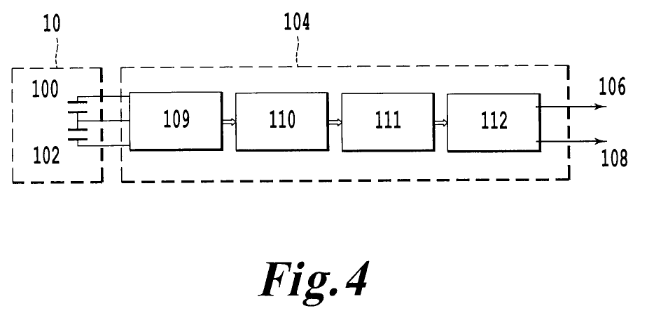

In FIG. 4, a level gauge using the probe 10 is schematized. In this gauge, the probe 10 is schematized as a level detecting capacity unit 100 and a reference capacity unit 102, wherein the outer cylinder 20 and the middle cylinder 22 function as electrodes to form the level detecting capacity unit 100 and can be used to determine a level of the AdBlue® where the probe 10 is located, for example in the AdBlue® tank. In a preferred embodiment, the level detecting capacity unit 100 determines the total level of the AdBlue®, from the bottom of the liquid in contact with a base 28 to the top liquid/vapor interface of the AdBlue® between the cylinders 20 and 22. Further, the middle cylinder 22 and the inner cylinder 24 function as electrodes to form the reference capacity unit 102 and can be used to determine a quality (purity) of the AdBlue® where the probe 10 is located. Thus, the probe 10 can detect a level of the AdBlue® and any anomalies in the quality of the AdBlue®.

As discussed above, the three cylinders (20, 22, and 24) are coaxial and should be accurately positioned with respect to one another. In this exemplary embodiment, the outer cylinder 20 has an internal diameter of 20 mm, an external diameter of 22 mm, and a thickness of 1 mm. Additionally, the middle cylinder 22 has an internal diameter of 12 mm, an external diameter of 14 mm, and a thickness of 1 mm. Further, the inner cylinder has an external diameter of 10 mm and the cylinder is a full cylinder or is hollow and has a thickness of 1 mm. In an alternative embodiment, cylinders with different diameters than those listed above can be used. The same formulas given below can be used with the different values for the cylinder dimensions. The cylinders can be sized such that a distance between the cylinders is enough to prevent capillarity of the liquid being measured. Further, regarding the height of the cylinders, the cylinders can extend to a top of the tank such that they contact the tank, or to any height which is desired to be measured.

Cmes, the capacitance measured by the level detecting capacity unit 100, varies with the height of liquid as may be approximated by the following equation:

$$Cmes = 2 {πɛ}_{0} {ɛ}_{r} \frac{h}{ln ( R 20 int / R 22 ext )} ,$$

where

ε₀ is the permittivity of a vacuum,

thus ε₀=8.854187·10⁻¹² F/m;

εᵣ is the relative permittivity of the liquid (AdBlue® in this example),

thus εᵣ≈80 for AdBlue®; and

h is the height of liquid (in m).

| | | |
|---|---|---|
| R20int | 10 | mm |
| R22ext | 7 | mm |
| R20int/R22ext | 1.429 | |
| ΔC (sensitivity) | 12.47776 | pF/mm |

This formula is of course an approximation since the value of Cmes is not equal to 0 when there is no liquid (but equal to the value measured with air).

Accordingly, ΔC (or the sensitivity of the electrode) is the change in capacitance measured per mm of liquid contacting unit 100. For example, if 10 mm of liquid contacts unit 100, then the measured capacitance will be 124.7776 pF higher than the measured capacitance when 0 mm of liquid contacts unit 100.

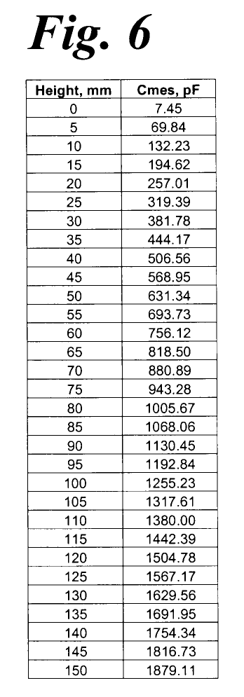

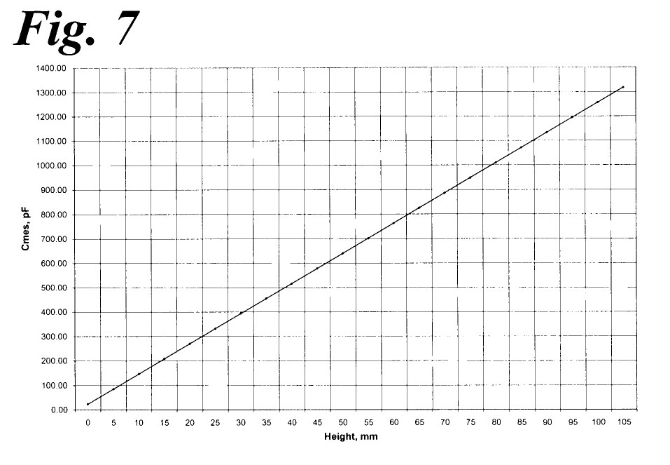

According to the above equation, the table shown in FIG. 6 and the graph shown in FIG. 7 can be generated to show the height of the AdBlue® obtained from the measured capacitance of the level detecting capacity unit 100.

In this exemplary embodiment, the relationship between Cmes and the height of the AdBlue® is linear. Thus, the level of the AdBlue® with respect to the gauge can be determined from the graph shown in FIG. 7. For example, a Cmes equal to 500.00 pF indicates that AdBlue® is covering approximately 41 mm of the probe 10. Additionally, the quantity of AdBlue® in the tank can be determined from the graph and the geometry of the tank. Other configurations for the electrodes can result in different relationships between Cmes and the height of the AdBlue®, which may be linear or not. The level of the AdBlue® can be determined based on these relationships.

Regarding the quality of the AdBlue®, the measured reference value, Cref, of the reference capacity unit 102 is measured with the electrodes of the middle cylinder 22 and the inner cylinder 24. It varies with the liquid height according to the following equation (approximation: see above):

$$Cref = 2 {πɛ}_{0} {ɛ}_{r} \frac{h}{ln ( R 22 int / R 24 ext )}$$

| | | |
|---|---|---|
| R22int | 6 | mm |
| R24ext | 5 | mm |
| R22int/R24ext | 1.200 | |
| ΔC (sensitivity) | 24.410 | pF/mm |

Accordingly, the purity of the AdBlue® can be determined using Cref. For example, assuming the height of the inner cylinder 24 to be 5 mm, then the measured value of Cref for pure AdBlue® being present up to the upper edge of this cylinder would be equal to approximately 122.05 pF (i.e., 24.410*5). However, if impurities are contained in the AdBlue®, then the Cref value will generally decrease (since AdBlue® has a rather high permittivity). For example, if the tank is filled with diesel fuel, then the measured Cref value would be approximately 1 pF.

The values determined by the level detecting capacity unit 100 and the reference capacity unit 102 are sent to an electronic device 104. The values are taken by analog measurement and the capacitance can be measured with a 100 kHz charge/discharge frequency, for example. This frequency can be controlled by the microcontroller discussed below. The microcontroller can measure the capacitance at a different frequency, if necessary. The preferred voltage level on the electrodes is, for example, between 2 and 5 volts, inclusive.

The three cylinders (20, 22, and 24) that comprise the level detecting capacity unit 100 and the reference capacity unit 102 include connectors extending from a bottom portion thereof (as shown in FIG. 2) that connect to the electronic device 104. The electronic device 104 can include a microcontroller, operational amplifiers, analog switches, and other passive components. The electronic device 104 can be an application-specific integrated circuit (ASIC) designed specifically for the probe 10. As can be seen in FIG. 4, the electronic device 104 comprises a signal receiving unit 109 to receive signals from the level detecting capacity unit 100 and the reference capacity unit 102 with the values recorded by the units modulated thereon. Charge transfer and sigma delta methods can be used to transfer the values to the electronic device 104. The signal receiving unit 109 sends the values from the level detecting capacity unit 100 and the reference capacity unit 102 to a calculation unit 110. The calculation unit 110 calculates the level of the liquid measured by the level detecting capacity unit 100. The calculation unit 110 also calculates the purity of the liquid measured by the reference capacity unit 102. The calculated values are sent from the calculation unit 110 to a look-up unit 111 that includes a plurality of look-up tables to determine a volume of the liquid in the tank based upon the calculated level of the liquid. Look-up tables for tanks having different shapes and volumes can be stored in the look-up unit 111. The values of the volume and purity of the liquid in the tank are sent to an output signal generation unit 112. The output signal generation unit 112 outputs a first output signal 106 from the probe 10 that represents the volume of liquid in the tank. The output signal generation unit 112 also outputs a second signal 108 from the probe 10 that provides information regarding the purity of the liquid in the tank (i.e. detection of the presence of other fuels instead of AdBlue®). The signals 106, 108 output from the output signal generate unit 112 can be used by the vehicles electronic control unit, for example. However, depending on the type of application, the signals 106, 108 can be used for different non-limiting purposes.

In an alternative embodiment, the electronic device 104 can also include a compensation unit to compensate for the environment inside the tank. For example, the compensation unit can adjust the calculated values based upon the effect of the temperature of the liquid in the tank.

Thus, the three-cylinder capacitive probe 10 is part of the motionless gauge. Specifically, the motionless gauge does not require a moving part for the entire gauging process, from capacity acquisition to data transmission. Accordingly, the level of liquid can be measured without any part moving relative to the three cylinders (20, 22, and 24) and the three cylinders (20, 22, and 24) do not move relative to one another. Thus, even when the level of liquid increases or decreases, the gauge can remain motionless.

Certain non-limiting embodiments have been described above. Some of the possible additional variations of these embodiments are described below.

The outer cylinder 20 and the middle cylinder 22 can be provided with holes to let the liquid pass through these cylinders. Additionally, a temperature sensor can be positioned inside the inner cylinder 24 such that the temperature sensor is not in direct contact with the liquid.

In an alternative embodiment, the probe 10 does not include the three cylinders (20, 22, and 24), but instead includes three parallel plates. The measurement and the calculation principles for the parallel plates are the same as for cylinders, only the formulas change. The formulas used to measure capacitance and purity are as follows:

C=ε0*εr*(S/d)

Cmes

| | | |
|---|---|---|
| a (length) | 0.105 | m |
| b (width) | 0.020 | m |
| S (surface area) | 0.00210 | m² |
| d (distance) | 0.002 | m |
| ΔC (sensitivity) | 0.744 | pF/mm |

Cref

| | | |
|---|---|---|
| a (length) | 0.005 | m |
| b (width) | 0.020 | m |
| S (surface area) | 0.00010 | m² |
| d (distance) | 0.001 | m |
| ΔC (sensitivity) | 0.071 | pF/mm |

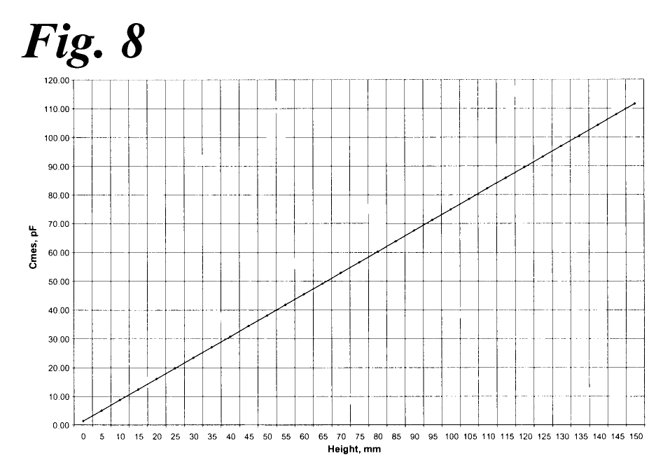

According to the above equation, the graph shown in FIG. 8 can be generated to show the height of the AdBlue® obtained from a measured capacitance utilizing the parallel plates.

In this exemplary embodiment, the relationship between Cmes and the height of the AdBlue® is linear. Thus, the level of the AdBlue® with respect to the gauge can be determined from the graph shown in FIG. 8. For example, a Cmes equal to 60.00 pF indicates that AdBlue® is covering approximately 81 mm of the plates. Additionally, the quantity of AdBlue® in the tank can be determined from the graph and the geometry of the tank. Other configurations for the electrodes can result in different relationships between Cmes and the height of the AdBlue®, which may be linear or not. The level of the AdBlue® can be determined based on these relationships.

In another alternative embodiment, the outer cylinder 20 and the middle cylinder 22 can be open vertically such that the liquid can easily enter the inside of these cylinders. Additionally, the cylinders would act as a filter against movement of the liquid inside the tank.

Obviously, numerous modifications and variations of the present invention are possible in light of the above teachings. It is therefore to be understood that within the scope of the appended claims, the invention may be practiced otherwise than as specifically described herein.

The present invention also relates to a method for calculating a level of liquid into a tank using a gauge as described above. More particularly, in said method, the two higher plates/cylinders are used as measuring capacitor and the shortest plate/cylinder and the longer one adjacent to it, are used as a reference capacitor of a level gauge comprising adequate electronics and charging means, and according to which:
Cref0, Cmes0, Crefmax and Cmesmax are stored in a memory, wherein Cref is the capacitance of the reference capacitor, Cmes is the capacitance of the measuring capacitor, Cref0 is the capacitance of the reference capacitor measured with air, Crefmax is the capacitance of the reference capacitor when the tank is completely full with the liquid to be measured, Cmes0 is the capacitance of the measuring capacitor measured with air and Cmesmax is the capacitance of the measuring capacitor when the tank is completely full with the liquid to be measured;
the actual values of Cref and Cmes are measured and used to check the quality of liquid and the correct functioning of the gauge, to check whether or not a reserve level is reached and to calculate the level of liquid inside the tank.

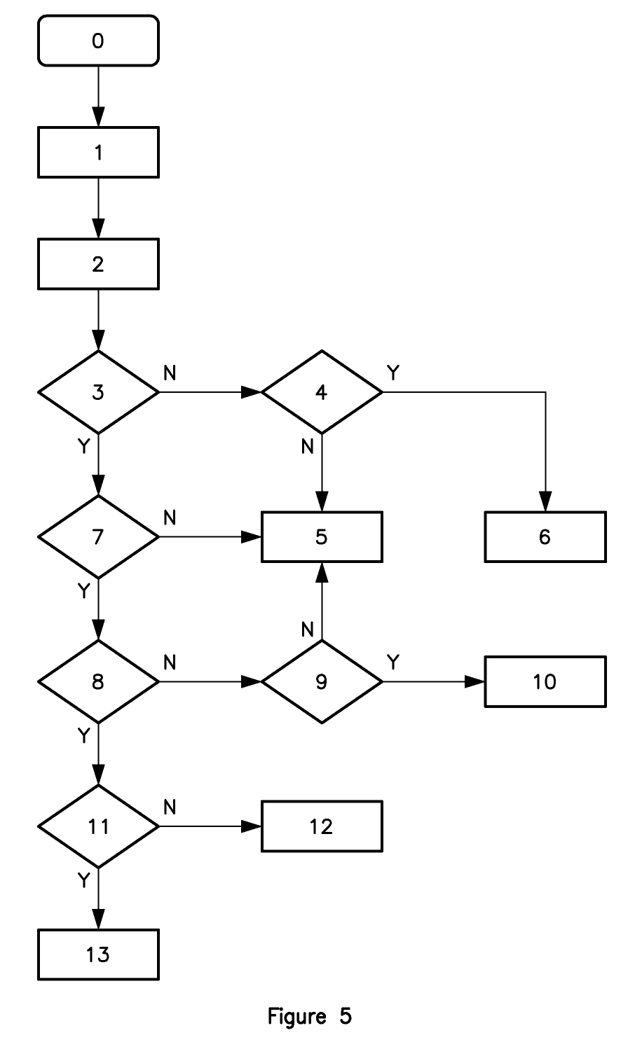

A specific method of this type will be described below with reference to FIG. 5.

In step 0, the method is started.

In step 1, the system is initialized to have a default level value of 0, a default sensor anomaly value of 0, and a default quality anomaly value of 0. A value of 0 for the quality and sensor anomaly values indicates that no anomaly is present, whereas a value of 1 indicates that there is an anomaly. The system then proceeds to step 2. In step 2, the Cmes and Cref values are measured.

The system then proceeds to step 3. In step 3, the Cref value is compared to the Crefₘₐₓ value and the Cref₀ value using the equation Cref₀<Cref≦Crefmax.

If the equation is not satisfied, the system proceeds to step 4. In step 4, the value of Cref is compared to Cref₀ and if it is not equal to Cref₀, the sensor anomaly value is set to 1 (step 5) and a signal is generated for the diagnostic output of the sensor based on the sensor anomaly value. If Cref=Cref₀, then a signal is generated for the diagnostic output of the sensor to indicate that the tank is empty (step 6).

Returning to step 3, if the equation Cref₀<Cref≦Crefmax is satisfied, the system proceeds to step 7.

In step 7, the Cmes value is compared to the Cmesₘₐₓ value and to the Cmes₀ value using the equation Cmes₀≦Cmes≦Cmesmax. If the equation is not satisfied, the system goes to step 5 (sensor anomaly value changed to 1 and signal generated). If the equation is satisfied, the system proceeds to step 8, where the value of Crefmax is compared to the value of Cmes using the equation Cmes>Crefmax.

If the equation of step 8 is not satisfied, the system checks if Cmes is equal to Crefmax (step 9). If so, then he proceeds to step 10 where a signal is generated for the diagnosis output of the sensor to indicate that the reserve level is reached. If the equation is not satisfied (Cmes not equal to Crefmax), the system goes again to step 5 (sensor anomaly value changed to 1 and signal generated).

If the equation is satisfied in step 8, then the system proceeds to step 11, where the Cref value is compared to Crefₘₐₓ using the equation Cref=Crefmax.

If the equation Cref=Crefmax is not satisfied, the system proceeds to step 12. In step 12, the quality anomaly value is set to 1 indicating that there is a liquid quality anomaly in the tank and a signal is generated for the output of the quality based on the quality anomaly value.

If the equation Cref=Crefmax in step 11 is satisfied, the system proceeds to step 13, where the fuel level is calculated as explained above and the corresponding level value signal is generated.

Finally, the present invention also relates to a SCR system for a combustion engine comprising a tank for storing a reducing agent, which uses a liquid level measuring method and apparatus as described above to evaluate the liquid level and quality inside said tank.

1. A tank of an SCR system equipped with a liquid level sensor (or gauge) comprising three plates or cylinders of conductive material which are fixed and rise up from the bottom of the tank, said plates or cylinders:
being spaced from each other but in a way such that their surfaces are parallel
having all three the same width in the case of plates, but only two of them, which are next to each other, having the same height while the third one is shorter.

2. A gauge suitable for the tank of claim 1, comprising:
a first electrode;
a second electrode of the same height as the first electrode;
a third electrode being shorter than the first and the second electrodes;
a cap positioned on a first end of the first electrode and a first end of the second electrode;
a base positioned on a second end of the first electrode, a second end of the second electrode, and a second end of the third electrode; and
a support positioned on a first end of the third electrode and in contact with a surface of the second electrode.

3. The gauge according to claim 2, further comprising a stand configured to receive the base therein.

4. The gauge according to claim 2, wherein the first electrode, the second electrode, and the third electrode are comprised of stainless steel.

5. The gauge according to claim 2, wherein the first electrode, the second electrode, and the third electrode are each coated with a film of electrical insulation.

6. The gauge according to claim 2, wherein
the first electrode is a first cylinder,
the second electrode is a second cylinder, and
the third electrode is a third cylinder.

7. The gauge according to claim 2, wherein
the first electrode is a first plate,
the second electrode is a second plate, and
the third electrode is a third plate.

8. A system for measuring a quantity and quality of a liquid, comprising:
a three-cylinder gauge, comprising:
a first cylinder including a first electrode,
a second cylinder positioned within the first cylinder and including a second electrode,
a third cylinder positioned within the second cylinder and including a third electrode; and
an electronic device configured to receive signals from the first cylinder, the second cylinder, and the third cylinder, wherein
the electronic device is configured to determine the quantity of the liquid from the signals received from the first electrode and the second electrode, and
the electronic device is configured to determine the quality of the liquid from the signals received from the second electrode and the third electrode.

9. A method for calculating a level of liquid into the tank according to claim 1, comprising:
using the two higher plates or cylinders as measuring capacitor and using the shortest plate or cylinder and the longer one adjacent to it, as a reference capacitor of a level gauge comprising adequate electronics and charging means,
storing Cref0, Cmes0, Crefmax and Cmesmax in a memory, wherein Cref is the capacitance of the reference capacitor, Cmes is the capacitance of the measuring capacitor, Cref0 is the capacitance of the reference capacitor measured with air, Crefmax is the capacitance of the reference capacitor when the tank is completely full with the liquid to be measured, Cmes0 is the capacitance of the measuring capacitor measured with air and Cmesmax is the capacitance of the measuring capacitor when the tank is completely full with the liquid to be measured; and
measuring and using the actual values of Cref and Cmes to check the quality of liquid and the correct functioning of the gauge, to check whether or not a reserve level in reached, and to calculate the level of liquid inside the tank.

10. An SCR system for a combustion engine comprising the tank according to claim 1 for storing a reducing agent.

11. A method for using the gauge according to claim 2 to calculate a level of liquid in a tank, wherein the first, second, and third electrodes of the gauge are either plates or cylinders,
said method comprising:
using the two higher first and second plates or cylinders as measuring capacitor and using the shortest third plate or cylinder and the longer one adjacent to it, as a reference capacitor of a level gauge comprising adequate electronics and charging means,
storing Cref0, Cmes0, Crefmax and Cmesmax in a memory, wherein Cref is the capacitance of the reference capacitor, Cmes is the capacitance of the measuring capacitor, Cref0 is the capacitance of the reference capacitor measured with air, Crefmax is the capacitance of the reference capacitor when the tank is completely full with the liquid to be measured, Cmes0 is the capacitance of the measuring capacitor measured with air and Cmesmax is the capacitance of the measuring capacitor when the tank is completely full with the liquid to be measured; and
measuring and using the actual values of Cref and Cmes to check the quality of liquid and the correct functioning of the gauge, to check whether or not a reserve level in reached, and to calculate the level of liquid inside the tank.

12. A method for calculating a level of liquid into a tank of an SCR system equipped with the gauge according to claim 2, wherein the first, second, and third electrodes of the gauge are either three plates or cylinders of conductive material which are fixed and rise up from the bottom of the tank, said plates or cylinders:
being spaced from each other but in a way such that their surfaces are parallel, and
having all three the same width in the case of plates, but only two of them, which are next to each other, having the same height while the third one is shorter.
said method comprising:
using the two higher first and second plates or cylinders as measuring capacitor and using the shortest third plate or cylinder and the longer one adjacent to it, as a reference capacitor of the level gauge comprising adequate electronics and charging means,
storing Cref0, Cmes0, Crefmax and Cmesmax in a memory, wherein Cref is the capacitance of the reference capacitor, Cmes is the capacitance of the measuring capacitor, Cref0 is the capacitance of the reference capacitor measured with air, Crefmax is the capacitance of the reference capacitor when the tank is completely full with the liquid to be measured, Cmes0 is the capacitance of the measuring capacitor measured with air and Cmesmax is the capacitance of the measuring capacitor when the tank is completely full with the liquid to be measured; and
measuring and using the actual values of Cref and Cmes to check the quality of liquid and the correct functioning of the gauge, to check whether or not a reserve level in reached, and to calculate the level of liquid inside the tank.

13. An SCR system for a combustion engine comprising a tank for storing a reducing agent, said tank being equipped with the gauge according to claim 2.

14. An SCR system for a combustion engine comprising a tank for storing a reducing agent, said tank being equipped with the system according to claim 8.

15. An SCR system for a combustion engine comprising a tank for storing a reducing agent, said tank having a liquid level being calculated by the method according to claim 9.

16. An SCR system for a combustion engine comprising a tank for storing a reducing agent, said tank having a liquid level being calculated by the method according to claim 11.

17. An SCR system for a combustion engine comprising a tank for storing a reducing agent, said tank having a liquid level being calculated by the method according to claim 12.
